(19) United States
(12) Patent Application Publication
(10) Pub. No.: US 2026/0202377 A1
(43) Pub. Date: Jul. 16, 2026

(54) GATE STRUCTURE OF BIOSENSOR TRANSISTOR

(71) Applicant: INTERNATIONAL BUSINESS MACHINES CORPORATION, Armonk, NY (US)

(72) Inventors: Uzma Rana, Slingerlands, NY (US); Takashi Ando, Eastchester, NY (US); Reinaldo Vega, Mahopac, NY (US); Sufi Zafar, Briarcliff Manor, NY (US)

(21) Appl. No.: 19/021,379

(22) Filed: Jan. 15, 2025

(51) Int. Cl. G01N 27/414

(52) U.S. Cl. CPC G01N 27/4145

(57) ABSTRACT

Embodiments of present invention provide a biosensor structure. The biosensor structure includes a sensing transistor having a source region, a drain region, and a gate, wherein the gate is over a channel region in a substrate between the source region and the drain region to include a gate metal, a gate dielectric layer, and a ferroelectric layer; a sensing layer conductively connected to the gate metal of the gate; and a bio layer on a top surface of the sensing layer. A method of manufacturing the biosensor structure is also provided.

### BACKGROUND

The present application relates to analytical devices from semiconductor structures. More particularly, it relates to a biosensor and method of manufacturing the biosensor.

Biosensors combine biological components with physicochemical detectors to detect analytes (i.e., chemical constituents that are of interest in an analytical procedure, such as ions and biomolecules). As such, biosensors play an important role in environmental applications and in the fields such as the food and healthcare industries. Some common examples of biosensors include, for example, blood glucose monitors and devices for detecting heavy metal ions and other contaminants in river water.

Field effect transistor (FET), particularly fin-type FET (FinFET) or nanosheet FET (NSFET) based biosensors have demonstrated their ability for rapid and label-free detection of proteins, nucleotide sequences, and viruses at some ultra-low concentration levels, thereby having the potential to become a transformative diagnostic technology. Their nanoscale size gives these FET based biosensors their advantages in device compactness, but in the meantime, introduces the need for enhanced sensitivity in detection.

### SUMMARY

Embodiments of present invention provide a biosensor structure. The biosensor structure includes a sensing transistor having a source region, a drain region, and a gate; where the gate includes a gate metal, a gate dielectric layer, and a ferroelectric layer, and is directly above a channel region in a substrate between the source region and the drain region; a sensing layer conductively connected to the gate metal of the gate; and a bio layer on a top surface of the sensing layer.

According to one embodiment, the biosensor structure further includes a controlling capacitor and a controlling terminal capacitively connected to the sensing transistor through the controlling capacitor, where the controlling capacitor includes a top conductive plate, a bottom conductive plate, and a dielectric layer between the top conductive plate and the bottom conductive plate.

According to another embodiment, the ferroelectric layer in the gate of the sensing transistor is a first ferroelectric layer, and the biosensor structure further includes a controlling capacitor conductively connected to the sensing layer with the controlling capacitor having a top conductive plate, a bottom conductive plate, and a second ferroelectric layer between the top conductive plate and the bottom conductive plate, and a controlling terminal conductively connected to the bottom conductive plate of the controlling capacitor.

In one embodiment, the sensing transistor and the controlling capacitor are at a frontside of the substrate and embedded in an interlevel dielectric (ILD) layer at a top surface of the substrate, and the controlling terminal is embedded in the ILD layer and access to the controlling terminal is provided at a top surface of the ILD layer.

In another embodiment, the sensing transistor and the controlling capacitor are at a frontside of the substrate and embedded in an interlevel dielectric (ILD) layer at a top surface of the substrate, and the controlling terminal is in the substrate and access to the controlling terminal is provided at a backside of the substrate that opposes the frontside of the substrate.

Embodiments of present invention further provide a biosensor structure that includes a sensing transistor having a source region, a drain region, and a gate, wherein the gate is directly above a channel region in a substrate between the source region and the drain region and includes at least a gate metal and a gate dielectric layer; a sensing layer conductively connected to the gate metal of the gate; a bio layer on a top surface of the sensing layer; and a controlling capacitor and a controlling terminal capacitively connected to the sensing transistor through the controlling capacitor, where the controlling capacitor includes a top conductive plate, a bottom conductive plate, and a ferroelectric layer between the top conductive plate and the bottom conductive plate.

In one embodiment, the ferroelectric layer in the controlling capacitor is a second ferroelectric layer, and the gate of the sensing transistor further includes a first ferroelectric layer between the gate metal and the channel region in the substrate.

In one embodiment, the first ferroelectric layer is a layer of X-doped HfO2 where X is selected from a group consisting of Si, Zr, Pb, Fe, La, and Al. In another embodiment, the first ferroelectric layer is different from the second ferroelectric layer in material.

In one embodiment, the first ferroelectric layer is between the gate metal and the gate dielectric layer.

Embodiments of present invention further provide a biosensor structure. The biosensor structure includes a fin-type transistor having a source region, a drain region, and a gate, wherein the gate saddles over a fin structure in a substrate between the source region and the drain region; includes a gate metal, a gate dielectric layer, and a ferroelectric layer; and is surrounded by a pair of sidewall spacers; a sensing layer conductively connected to the gate metal of the gate; and a bio layer on a top surface of the sensing layer.

According to one embodiment, the biosensor structure further include a controlling capacitor directly on top of the gate of the fin-type transistor; where the controlling capacitor includes a top conductive plate, a bottom conductive plate, and a dielectric layer between the top conductive plate and the bottom conductive plate.

According to another embodiment, the gate of the fin-type transistor and the controlling capacitor are embedded in an interlevel dielectric (ILD) layer at a top surface of the substrate, the biosensor structure further includes a sensing layer embedded in the ILD layer, where the sensing layer is conductively connected to the bottom conductive plate of the controlling capacitor through a contact region formed above one of the pair of sidewall spacers.

In one embodiment, the bottom conductive plate of the controlling capacitor is in direct contact with, thereby conductively connected to, the gate metal of the gate of the fin-type transistor.

According to one embodiment, the ferroelectric layer in the gate of the fin-type transistor is a first ferroelectric layer, the biosensor structure further includes a controlling capacitor directly on top of the gate of the fin-type transistor, where the controlling capacitor includes a top conductive plate, a bottom conductive plate, and a second ferroelectric layer between the top conductive plate and the bottom conductive plate.

In one embodiment, the first and second ferroelectric layers are different in material, and are respectively a layer of X-doped HfO2 where X is selected from a group consisting of Si, Zr, Pb, Fe, La, and Al.

### BRIEF DESCRIPTION OF THE DRAWINGS

The present invention will be understood and appreciated more fully from the following detailed description of embodiments of present invention, taken in conjunction with accompanying drawings of which:

FIG. 1 is a demonstrative illustration of cross-sectional view of a biosensor according to a first embodiment of present invention;

FIG. 2 is a demonstrative illustration of cross-sectional view of a biosensor according to a second embodiment of present invention;

FIG. 3 is a demonstrative illustration of cross-sectional view of a biosensor according to a third embodiment of present invention;

FIG. 4 is a demonstrative illustration of cross-sectional view of a biosensor according to a fourth embodiment of present invention;

FIG. 5 is a demonstrative illustration of cross-sectional view of a biosensor according to a fifth embodiment of present invention;

FIG. 6 is a demonstrative illustration of cross-sectional view of a biosensor according to a sixth embodiment of present invention;

FIGS. 7-18 are demonstrative illustrations of cross-sectional views of the biosensor during a process of manufacturing thereof according to embodiments of present invention; and

FIG. 19 is a demonstrative illustration of a flow-chart of a method of manufacturing a biosensor according to embodiments of present invention.

It will be appreciated that for simplicity and clarity purpose, elements shown in the drawings have not necessarily been drawn to scale. Further, and if applicable, in various functional block diagrams, two connected devices and/or elements may not necessarily be illustrated as being connected. In some other instances, grouping of certain elements in a functional block diagram may be solely for the purpose of description and may not necessarily imply that they are in a single physical entity, or they are embodied in a single physical entity.

### DETAILED DESCRIPTION

In the below detailed description and the accompanying drawings, it is to be understood that various layers, structures, and regions shown in the drawings are both demonstrative and schematic illustrations thereof that are not drawn to scale. In addition, for the ease of explanation, one or more layers, structures, and regions of a type commonly used to form semiconductor devices or structures may not be explicitly shown in a given illustration or drawing. This does not imply that any layers, structures, and regions not explicitly shown are omitted from the actual semiconductor structures. Furthermore, it is to be understood that the embodiments discussed herein are not limited to the particular materials, features, and processing steps shown and described herein. In particular, with respect to semiconductor processing steps, it is to be emphasized that the descriptions provided herein are not intended to encompass all of the processing steps that may be required to form a functional semiconductor integrated circuit device. Rather, certain processing steps that are commonly used in forming semiconductor devices, such as, for example, wet cleaning and annealing steps, are purposefully not described herein for economy of description.

It is to be understood that the terms "about" or "substantially" as used herein with regard to thicknesses, widths, percentages, ranges, etc., are meant to denote being close or approximate to, but not exactly. For example, the term "about" or "substantially" as used herein implies that a small margin of error may be present such as, by way of example only, 1% or less than the stated amount. Likewise, the terms "on", “over”, or “on top of” that are used herein to describe a positional relationship between two layers or structures are intended to be broadly construed and should not be interpreted as precluding the presence of one or more intervening layers or structures.

Moreover, although various reference numerals may be used across different drawings, the same or similar reference numbers are used throughout the drawings to denote the same or similar features, elements, or structures, and thus detailed explanations of the same or similar features, elements, or structures may not be repeated for each of the drawings for economy of description. Labelling for the same or similar elements in some drawings may be omitted as well in order not to overcrowd the drawings.

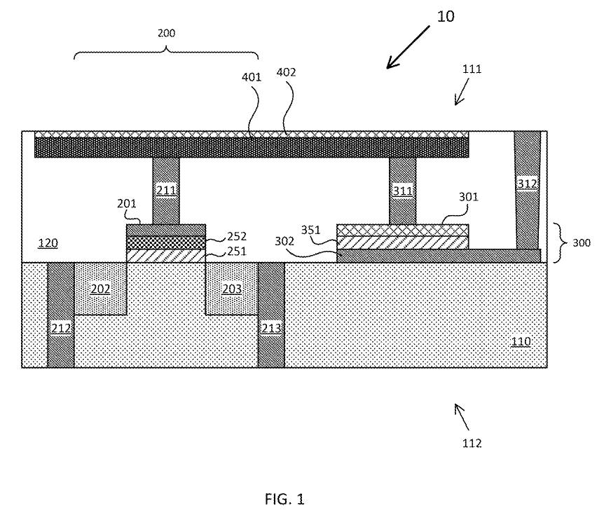

FIG. 1 is a demonstrative illustration of cross-sectional view of a biosensor according to a first embodiment of present invention. More particularly, the embodiment provides a biosensor structure 10 which includes a semiconductor substrate 110 that has a frontside 111 and a backside 112 opposing the frontside 111. As is illustrated in FIG. 1, the frontside 111 of the substrate 110 refers to a top side of the substrate 110 and the backside 112 of the substrate 110 refers to a bottom side of the substrate 110.

At the frontside 111 of the substrate 110, there may be formed a sensing transistor 200. The sensing transistor 200 may include a source region 202, a drain region 203, and a gate including a gate metal 201 over a channel region in the substrate 110 between the source region 202 and the drain region 203. In the substrate 110, there may be formed a source contact 212 and a drain contact 213 in direct contact with the source region 202 and the drain region 203 respectively. Accesses to the source contact 212 and the drain contact 213 may be provided at the backside 112 of the substrate 110. Optionally, a dielectric layer (not shown) may be formed at the backside 112 of the substrate 110 and accesses to the source contact 212 and the drain contact 213 may be made through a controlling surface formed at a bottom surface of the dielectric layer, via one or more contact vias formed in the dielectric layer.

At the frontside 111 of the substrate 110, there may also be formed a controlling capacitor 300, or a capacitive structure, that includes a top conductive plate 301 and a bottom conductive plate 302. The top and bottom conductive plates 301 and 302 may be made of, for example, gold (Au) or polysilicon (poly-Si) and may be separated by a dielectric layer 351. The dielectric layer 351 may be a layer of dielectric material such as, for example, silicon-oxide (SiOx), silicon-nitride (SiN), silicon-carbide (SiC), silicon-carbonitride (SiCN), or other suitable materials.

The sensing transistor 200 and the controlling capacitor 300 are formed or embedded in and surrounded by a dielectric layer 120 that is formed on top of the substrate 110. Embedded inside the dielectric layer 120, there may be formed a gate contact 211 in contact with the gate metal 201 and a lead contact 311 in contact with the top conductive plate 301. A controlling terminal 312 is formed in contact with the bottom conductive plate 302 of the controlling capacitor 300 and embedded in the dielectric layer 120. Access to the controlling terminal 312 may be provided from the frontside 111 of the substrate 110 such as at a top surface of the dielectric layer 120. In one embodiment, the dielectric layer 120 may include a same dielectric material as that of the dielectric layer 351 between the first and the second conductive plates 301 and 302 of the controlling capacitor 300.

At or near the top of the dielectric layer 120, a sensing layer 401 is formed in contact with both the gate contact 211 of the sensing transistor 200 and the lead contact 311 of the controlling capacitor 300. The sensing layer 401 may be a layer of conductive material such as, for example, copper (Cu) and in one embodiment may be a metal line of a metal level of a back-end-of-line (BEOL). According to one embodiment, a bio layer 402, such as a monolayer of biotin proteins, may be formed on top of the sensing layer 401 thereby forming a sensing surface. In other words, the sensing surface includes the bio layer 402 and the sensing layer 401.

The biosensor structure 10 may be used in sensing or detecting certain biomolecules in a test solution. During the sensing or detecting process, the sensing surface may receive or accept a test solution. The test solution may be made in contact with the sensing layer 401, through the bio layer 402, and may thus cause biochemical reaction in the sensing layer 401. This biochemical reaction in-turn affects, via the gate contact 211, a gate voltage at the gate metal 201. A control voltage applied to the controlling capacitor 300 at the controlling terminal 312 may also affect the gate voltage via the lead contact 311 and the sensing layer 401. The controlling terminal 312 is capacitively connected to the sensing layer 401 through the controlling capacitor 300.

According to one embodiment, the gate metal 201 may be formed over the channel region in the substrate 110 via a gate dielectric layer 251 and a ferroelectric layer 252, thereby forming the gate of the sensing transistor 200. The gate dielectric layer 251 may be a layer of high-k dielectric material such as, for example, a layer of hafnium-oxide (HfO₂) and the ferroelectric layer 252 may be a layer of X-doped HfO₂ where X may be Si, Zr, Pb, Fe, La, Al. The ferroelectric layer 252 may additionally be PbZrTiO₃, BiFeO₃, ZrO₂ as well. The ferroelectric layer 252 may be formed on top of or underneath the gate dielectric layer 251. In other words, the ferroelectric layer 252 may be formed between the gate metal 201 and the gate dielectric layer 251 or between the gate dielectric layer 251 and the channel region in the substrate 110.

The combinational stack of paraelectric and ferroelectric materials, i.e., the stack of the gate dielectric layer 251 and the ferroelectric layer 252 effectively reduces the subthreshold swing below the thermal limit of 60 mV/decade and creates a negative capacitance between the gate metal 201 and the substrate 110, which makes the sensing transistor 200 a negative capacitance FET (NCFET) to function as a voltage amplifier. The use of the ferroelectric layer 252 in the gate of the sensing transistor 200 enhances the sensitivity of the sensing transistor 200, resulting in a bigger change in current in the channel region between the source region 202 and drain region 203. In other words, the current change in the sensing transistor 200 is bigger than otherwise in a conventional sensing transistor which does not have the ferroelectric layer 252.

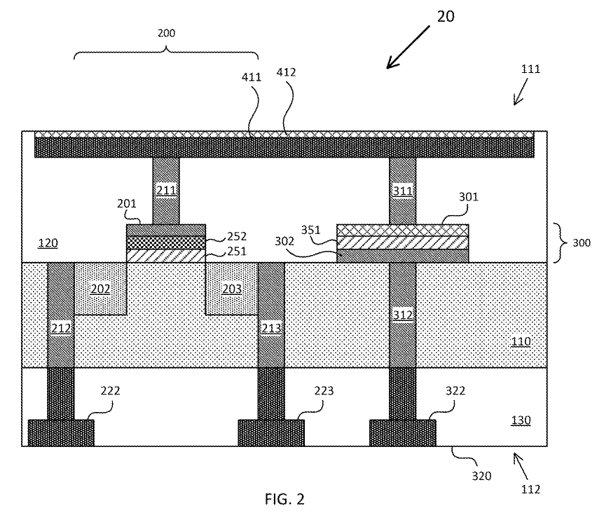

FIG. 2 is a demonstrative illustration of cross-sectional view of a biosensor according to a second embodiment of present invention. More particularly, the embodiment provides a biosensor structure 20 that includes a dielectric layer 120 on top of a substrate 110. At a frontside 111 of the substrate 110 there formed a sensing transistor 200 and a controlling capacitor 300, both of which are substantially similar to the sensing transistor 200 and the controlling capacitor 300 in the biosensor structure 10 illustrated in FIG. 1. For example, the sensing transistor 200 includes a source region 202, a drain region 203, and a gate that includes a gate metal 201 on top of a channel region in the substrate 110 via a gate dielectric layer 251 and a ferroelectric layer 252. The controlling capacitor 300, embedded in the dielectric layer 120, includes a top and a bottom conductive plates 301 and 302 that are separated by a dielectric layer 351. A gate contact 211 and a lead contact 311 may be formed in the dielectric layer 120 in contact with, respectively, the gate metal 201 of the sensing transistor 200 and the top conductive plate 301 of the controlling capacitor 300. A source contact 212 and a drain contact 213 may be formed in the substrate 110 in direct contact with the source region 202 and the drain region 203.

According to one embodiment, a controlling terminal 312 may be formed in the substrate 110 in direct contact with the bottom conductive plate 302 of the controlling capacitor 300. Access to the controlling terminal 312, the source contact 212, and the drain contact 213 may be provided at the backside 112 of the substrate 110, different from that of the biosensor structure 10 illustrated in FIG. 1.

At or near the top of the dielectric layer 120, a sensing layer 411 is formed in contact with both the gate contact 211 of the sensing transistor 200 and the lead contact 311 of the controlling capacitor 300. A bio layer 412 may be formed on top of the sensing layer 411. The sensing layer 411 and the bio layer 412 together form a sensing surface for accepting a test solution during sensing, detecting, or testing. Taking the advantage of the controlling terminal 312 being formed in the substrate 110 and access is provided at the backside 112 of the substrate 110, according to one embodiment, the sensing layer 411 and the bio layer 412 may be formed bigger, or much bigger, than those in the biosensor structure 10 illustrated in FIG. 1. The bigger sensing surface further enhances sensitivity of the biosensor structure 20 in addition to the sensitivity enhancement brought by the use of the ferroelectric layer 252 in the gate of the sensing transistor 200.

The biosensor structure 20 may optionally include a dielectric layer 130 formed at the backside 112 of the substrate 110. A controlling surface 320 may be provided at a bottom surface of the dielectric layer 130, which provides access to the controlling terminal 312 through a first contact via 322 and accesses to the source contact 212 and the drain contact 213 through a second contact via 222 and a third contact via 223. The first, second, and third contact vias 322, 222, and 223 are embedded in the dielectric layer 130.

By having the controlling surface 320 at the backside 112 of the substrate 110, more particularly at the bottom surface of the dielectric layer 130, the biosensor structure 20 may be formed to have a bigger sensing surface at the sensing layer 411, as being described above, which enhances the sensitivity of the biosensor structure 20. In the meantime, it helps avoid potential issues such as, for example, complication in co-packaging the sensing surface with the controlling surface when both are formed at the frontside 111 of the substrate 110.

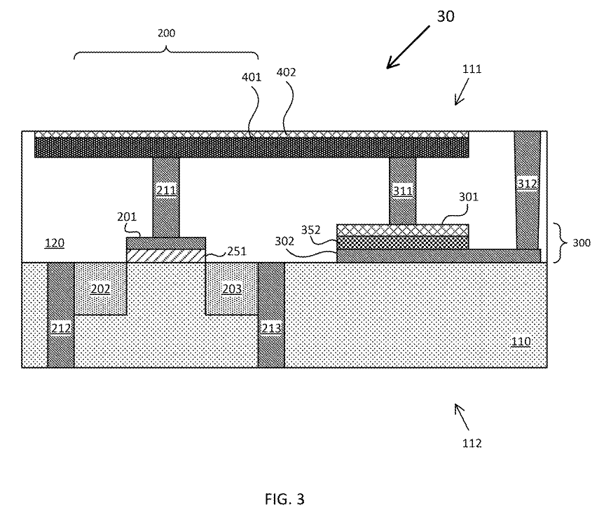

FIG. 3 is a demonstrative illustration of cross-sectional view of a biosensor according to a third embodiment of present invention. More particularly, the embodiment provides a biosensor structure 30 that includes a dielectric layer 120 on top of a substrate 110. At a frontside 111 of the substrate 110 there formed a sensing transistor 200 and a controlling capacitor 300. The sensing transistor 200 may include a source region 202, a drain region 203, and a gate that includes a gate metal 201 on top of a channel region in the substrate 110 via a gate dielectric layer 251. The gate dielectric layer 251 may be a layer of high-k dielectric material such as, for example, HfO. In the substrate 110, there may be formed a source contact 212 and a drain contact 213 in direct contact with the source region 202 and the drain region 203 respectively. Accesses to the source contact 212 and the drain contact 213 may be provided at the backside 112 of the substrate 110. Optionally, a dielectric layer (not shown) may be formed at the backside 112 of the substrate 110 and accesses to the source contact 212 and the drain contact 213 may be made through a controlling surface formed at a bottom surface of the dielectric layer, via one or more contact vias formed in the dielectric layer.

At the frontside 111 of the substrate 110, there may also be formed a controlling capacitor 300, or a capacitive structure, that includes a top conductive plate 301 and a bottom conductive plate 302. The top and bottom conductive plates 301 and 302 may be made of gold (Au) or polysilicon (poly-Si).

According to one embodiment, the top and bottom conductive plates 301 and 302 may be separated by a ferroelectric layer 352, instead of a dielectric layer 351 as is in the biosensor structures 10 and 20. The use of the ferroelectric layer 352 may create a negative capacitance of the controlling capacitor 300, causing the controlling capacitor 300 to function as a voltage amplifier thereby enhancing the impact of a controlling voltage applied to the sensing transistor 200 via the controlling capacitor 300. The ferroelectric layer 352 may be a layer of X-doped HfO₂ where X may be Si, Zr, Pb, Fe, La, Al. The ferroelectric layer 352 may additionally be PbZrTiO₃, BiFeO₃, ZrO₂ as well. In one embodiment, the ferroelectric layer 352 may be different from the ferroelectric layer 252 in material.

Embedded inside the dielectric layer 120, there may be formed a gate contact 211 in contact with the gate metal 201 and a lead contact 311 in contact with the top conductive plate 301. A controlling terminal 312 is formed in contact with the bottom conductive plate 302 of the controlling capacitor 300 and embedded in the dielectric layer 120. Access to the controlling terminal 312 may be provided from the frontside 111 of the substrate 110 such as at a top surface of the dielectric layer 120. In one embodiment, the dielectric layer 120 may be a layer of dielectric material such as SiOx, SiN, SiC, SiCN, or other suitable materials.

At or near the top of the dielectric layer 120, a sensing layer 401 is formed in contact with both the gate contact 211 of the sensing transistor 200 and the lead contact 311 of the controlling capacitor 300. The sensing layer 401 may be a layer of conductive material such as, for example, copper (Cu). According to one embodiment, a bio layer 402, such as a monolayer of biotin proteins, may be formed on top of the sensing layer 401 that, together with the sensing layer 401, forms a sensing surface.

The biosensor structure 30 may be used in sensing or detecting certain biomolecules in a test solution. During the sensing or detecting process, the sensing surface may be adapted to receive or accept a test solution, the test solution may be made in contact with the sensing layer 401, through the bio layer 402, and may thus cause biochemical reaction in the sensing layer 401. This biochemical reaction in-turn affects, via the gate contact 211, a gate voltage at the gate metal 201. The controlling terminal 312 is capacitively connected to the sensing layer 401 through the controlling capacitor 300. The use of the ferroelectric layer 352 may cause the controlling capacitor 300 to amplify a controlling voltage applied to the controlling terminal 312, thereby resulting a bigger change in current in the channel region between the source region 202 and drain region 203.

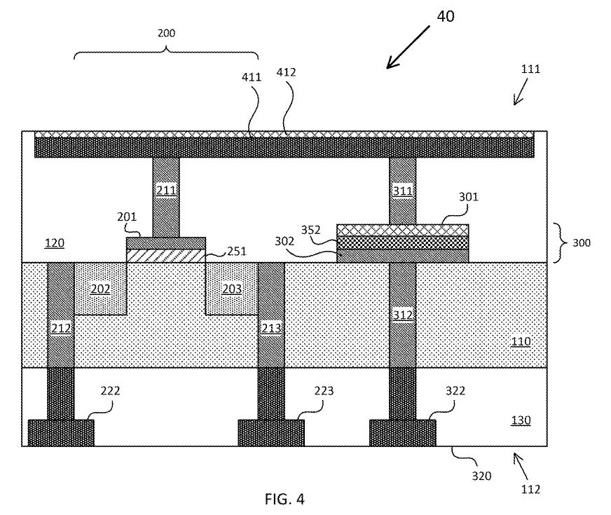

FIG. 4 is a demonstrative illustration of cross-sectional view of a biosensor according to a fourth embodiment of present invention. More particularly, the embodiment provides a biosensor structure 40 that includes a dielectric layer 120 on top of a substrate 110. At a frontside 111 of the substrate 110 there formed a sensing transistor 200 and a controlling capacitor 300, both of which are substantially similar to the sensing transistor 200 and the controlling capacitor 30 in the biosensor structure 30 illustrated in FIG. 3. For example, the sensing transistor 200 includes a source region 202, a drain region 203, and a gate that includes a gate metal 201 on top of a channel region in the substrate 110 via a gate dielectric layer 251. The controlling capacitor 300, embedded in the dielectric layer 120, includes a top and a bottom conductive plates 301 and 302 that are separated by a ferroelectric layer 352. A gate contact 211 and a lead contact 311 may be formed in the dielectric layer 120 in contact with, respectively, the gate metal 201 of the sensing transistor 200 and the top conductive plate 301 of the controlling capacitor 300. A source contact 212 and a drain contact 213 may be formed in the substrate 110 in direct contact with the source region 202 and the drain region 203.

According to one embodiment, a controlling terminal 312 may be formed in the substrate 110 in direct contact with the bottom conductive plate 302 of the controlling capacitor 300. Access to the controlling terminal 312, the source contact 212, and the drain contact 213 may be provided at the backside 112 of the substrate 110, different from that of the biosensor structure 30 illustrated in FIG. 3.

At or near the top of the dielectric layer 120, a sensing layer 411 is formed in contact with both the gate contact 211 of the sensing transistor 200 and the lead contact 311 of the controlling capacitor 300. A bio layer 412 may be formed on top of the sensing layer 411. The sensing layer 411 and the bio layer 412 together form a sensing surface for accepting a test solution during sensing, detecting, and/or testing. Taking the advantage of the controlling terminal 312 being formed in the substrate 110 and access is provided at the backside 112 of the substrate 110, according to one embodiment, the sensing layer 411 and the bio layer 412 may be formed bigger, or much bigger, than those in the biosensor structure 30 illustrated in FIG. 3. The bigger sensing surface further enhances sensitivity of the biosensor structure 40 in addition to the sensitivity enhancement brought by the use of the ferroelectric layer 352 used between the top and bottom conductive plates 301 and 302 of the controlling capacitor 300.

The biosensor structure 40 may optionally include a dielectric layer 130 formed at the backside 112 of the substrate 110. A controlling surface 320 may be provided at a bottom surface of the dielectric layer 130, which provides access to the controlling terminal 312 through a first contact via 322 and accesses to the source contact 212 and the drain contact 213 through a second contact via 222 and a third contact via 223. The first, second, and third contact vias 322, 222, and 223 are embedded in the dielectric layer 130.

By having the controlling surface 320 at the backside 112 of the substrate 110, more particularly at a bottom surface of the dielectric layer 130, the biosensor structure 40 may be formed to have a bigger sensing surface at the sensing layer 411, as being described above, which enhances the sensitivity of the biosensor structure 40. In the meantime, it helps avoid potential issues such as, for example, complication in co-packaging the sensing surface with the controlling surface when both are formed at the frontside 111 of the substrate 110.

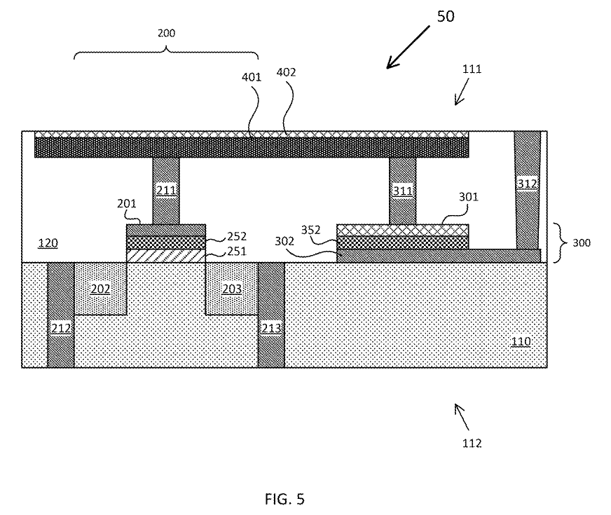

FIG. 5 is a demonstrative illustration of cross-sectional view of a biosensor according to a fifth embodiment of present invention. More particularly, the embodiment provides a biosensor structure 50 that includes a dielectric layer 120 on top of a substrate 110. At a frontside 111 of the substrate 110 there formed a sensing transistor 200 and a controlling capacitor 300. The sensing transistor 200 may include a source region 202, a drain region 203, and a gate that includes a gate metal 201 on top of a channel region in the substrate 110 via a gate dielectric layer 251 and a ferroelectric layer 252. The gate dielectric layer 251 may be a layer of high-k dielectric material such as, for example, HfO and the ferroelectric layer 252 may be a layer of X-doped HfO₂ where X may be Si, Zr, Pb, Fe, La, Al. The ferroelectric layer 252 may additionally be PbZrTiO₃, BiFeO₃, ZrO₂ as well. In the substrate 110, there may also be formed a source contact 212 and a drain contact 213 in direct contact with the source region 202 and the drain region 203 respectively. Accesses to the source contact 212 and the drain contact 213 may be provided at the backside 112 of the substrate 110. Optionally, a dielectric layer (not shown) may be formed at the backside 112 of the substrate 110 and accesses to the source contact 212 and the drain contact 213 may be made through a controlling surface formed at a bottom surface of the dielectric layer, via one or more contact vias formed in the dielectric layer.

At the frontside 111 of the substrate 110, there may also be formed a controlling capacitor 300, or a capacitive structure, that includes a top conductive plate 301 and a bottom conductive plate 302. The top and bottom conductive plates 301 and 302 may be made of gold (Au) or polysilicon (poly-Si).

According to one embodiment, the top and bottom conductive plates 301 and 302 may be separated by a ferroelectric layer 352, instead of a dielectric layer 351 as in the biosensor structures 10 and 20. The use of the ferroelectric layer 352 may create a negative capacitance of the controlling capacitor 300, causing the controlling capacitor 300 to function as a voltage amplifier thereby enhancing the impact of a controlling voltage applied to the sensing transistor 200 via the controlling capacitor 300. The ferroelectric layer 352 may be a layer of X-doped HfO₂ where X may be Si, Zr, Pb, Fe, La, Al. The ferroelectric layer 352 may additionally be PbZrTiO₃, BiFeO₃, ZrO₂ as well. In one embodiment, the ferroelectric layer 352 may be different from the ferroelectric layer 252 in material.

Embedded inside the dielectric layer 120, there may be formed a gate contact 211 in contact with the gate metal 201 and a lead contact 311 in contact with the top conductive plate 301. A controlling terminal 312 is formed in contact with the bottom conductive plate 302 of the controlling capacitor 300 and embedded in the dielectric layer 120. Access to the controlling terminal 312 may be provided from the frontside 111 of the substrate 110 such as at a top surface of the dielectric layer 120. In one embodiment, the dielectric layer 120 may be a layer of dielectric material such as SiOx, SiN, SiC, SiCN, or other suitable materials.

At or near the top of the dielectric layer 120, a sensing layer 401 is formed in contact with both the gate contact 211 of the sensing transistor 200 and the lead contact 311 of the controlling capacitor 300. The sensing layer 401 may be a layer of conductive material such as, for example, copper (Cu). According to one embodiment, a bio layer 402, such as a monolayer of biotin proteins, may be formed on top of the sensing layer 401 that, together with the sensing layer 401, forms a sensing surface.

The biosensor structure 50 may be used in sensing or detecting certain biomolecules in a test solution. During the sensing or detecting process, the sensing surface may be adapted to receive or accept a test solution, the test solution may be made in contact with the sensing layer 401, through the bio layer 402, and may thus cause biochemical reaction in the sensing layer 401. This biochemical reaction in-turn affects, via the gate contact 211, a gate voltage at the gate metal 201. The use of the ferroelectric layer 252 in the gate of the sensing transistor 200 enhances the sensitivity of the sensing transistor 200, resulting in a bigger change in current in the channel region between the source region 202 and drain region 203. In the meantime, the controlling terminal 312 is capacitively connected to the sensing layer 401 through the controlling capacitor 300. The use of the ferroelectric layer 352 may also cause the controlling capacitor 300 to amplify a controlling voltage applied to the controlling terminal 312, thereby resulting a bigger change in current in the channel region between the source region 202 and drain region 203.

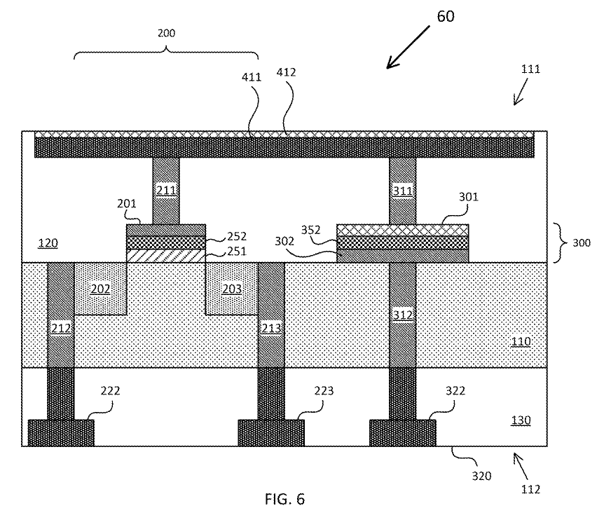

FIG. 6 is a demonstrative illustration of cross-sectional view of a biosensor according to a sixth embodiment of present invention. More particularly, the embodiment provides a biosensor structure 60 that includes a dielectric layer 120 on top of a substrate 110. At a frontside 111 of the substrate 110 there formed a sensing transistor 200 and a controlling capacitor 300, both of which are substantially similar to the sensing transistor 200 and the controlling capacitor 300 in the biosensor structure 50 illustrated in FIG. 5. For example, the sensing transistor 200 includes a source region 202, a drain region 203, and a gate that includes a gate metal 201 on top of a channel region in the substrate 110 via a gate dielectric layer 251 and a ferroelectric layer 252. The controlling capacitor 300, embedded in the dielectric layer 120, includes a top and a bottom conductive plates 301 and 302 that are separated by a ferroelectric layer 352. A gate contact 211 and a lead contact 311 may be formed in the dielectric layer 120 in contact with, respectively, the gate metal 201 of the sensing transistor 200 and the top conductive plate 301 of the controlling capacitor 300. A source contact 212 and a drain contact 213 may be formed in the substrate 110 in direct contact with the source region 202 and the drain region 203.

According to one embodiment, a controlling terminal 312 may be formed in the substrate 110 in direct contact with the bottom conductive plate 302 of the controlling capacitor 300. Access to the controlling terminal 312, the source contact 212, and the drain contact 213 may be provided at the backside 112 of the substrate 110, different from that of the biosensor structure 30 illustrated in FIG. 5.

At or near the top of the dielectric layer 120, a sensing layer 411 is formed in contact with both the gate contact 211 of the sensing transistor 200 and the lead contact 311 of the controlling capacitor 300. A bio layer 412 may be formed on top of the sensing layer 411. The sensing layer 411 and the bio layer 412 together form a sensing surface for accepting a test solution during sensing, detecting, and/or testing. Taking the advantage of the controlling terminal 312 being formed in the substrate 110 and access is provided at the backside 112 of the substrate 110, according to one embodiment, the sensing layer 411 and the bio layer 412 may be formed bigger, or much bigger, than those in the biosensor structure 50 illustrated in FIG. 5. The bigger sensing surface further enhances sensitivity of the biosensor structure 60 in addition to the sensitivity enhancement brought by the use of the ferroelectric layer 252 under the gate metal 201 in the gate of the sensing transistor 200, and the use of the ferroelectric layer 352 used between the top and bottom conductive plates 301 and 302 of the controlling capacitor 300.

The biosensor structure 60 may optionally include a dielectric layer 130 formed at the backside 112 of the substrate 110. A controlling surface 320 may be provided at a bottom surface of the dielectric layer 130, which provides access to the controlling terminal 312 through a first contact via 322 and accesses to the source contact 212 and the drain contact 213 through a second contact via 222 and a third contact via 223. The first, second, and third contact vias 322, 222, and 223 are embedded in the dielectric layer 130.

By having the controlling surface 320 at the backside 112 of the substrate 110, more particularly at a bottom surface of the dielectric layer 130, the biosensor structure 60 may be formed to have a bigger sensing surface at the sensing layer 411, as being described above, and potential issues such as, for example, complication in co-packaging the sensing surface with the controlling surface when both are at the frontside 111 of the substrate 110.

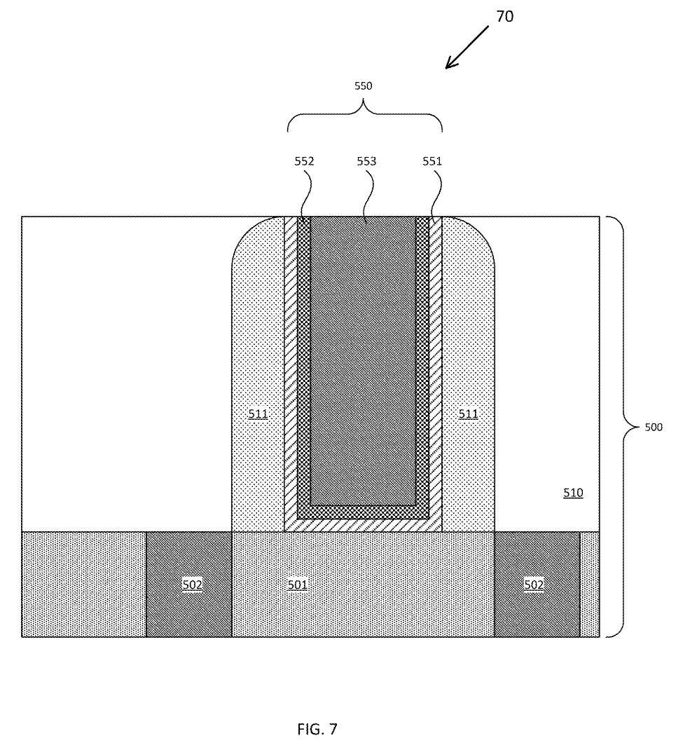

FIGS. 7-18 are demonstrative illustrations of cross-sectional views of a biosensor during a process of manufacturing thereof according to embodiments of present invention. As a non-limiting example, FIGS. 7-18 illustrate forming a biosensor or a biosensor structure using a fin-type FET (FinFET) as a sensing transistor. However, embodiments of present invention are not limited in this aspect and other types of transistors such as, for example, a planar transistor, a nanosheet transistor (NSFET), a vertical transistor (VFET) may be used as a sensing transistor of the biosensor, and the biosensor formed therefrom may be fabricated or manufactured in similar manners.

FIG. 7 is a demonstrative illustration of a cross-sectional view of a biosensor 70 at a step of manufacturing thereof according to one embodiment of present invention. The cross-section is made along a length of a metal gate, or a fin, of a fin-type FET used in the biosensor 70. More particularly, embodiments of present invention provide forming a fin-type FET 500 that includes a fin structure 501 and a metal gate 550 that saddles over the fin structure 501 between a first and a second source/drain (S/D) region 502. The fin structure 501 may be made of silicon (Si) or silicon-germanium (SiGe). The metal gate 550 may include a gate dielectric layer 551 on top of the fin structure 501, a ferroelectric layer 552 on top of the gate dielectric layer 551, and one or more gate metal 553 on top of the ferroelectric layer 552. A channel region may be directly underneath the gate dielectric layer 551 in the fin structure 501 between the S/D regions 502. A pair of sidewall spacers 511 may be formed at sidewalls of the metal gate 550. The metal gate 550 may be embedded in a dielectric layer 510, which may be an interlevel dielectric (ILD) layer. In one embodiment, the ferroelectric layer 552 may be formed underneath the gate dielectric layer 551.

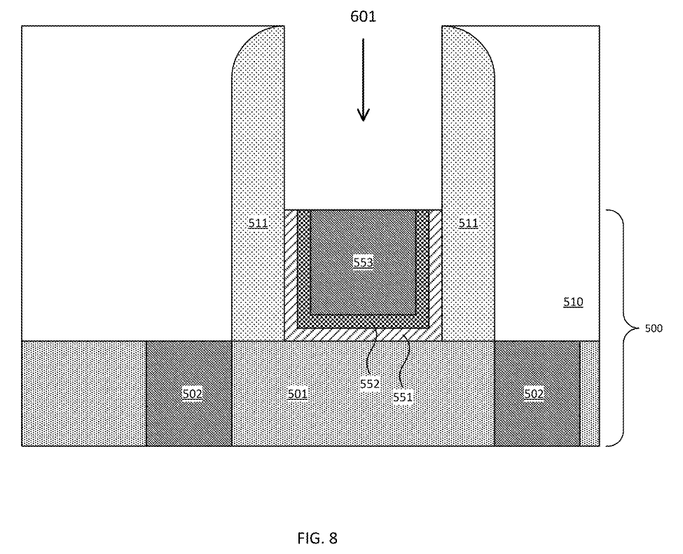

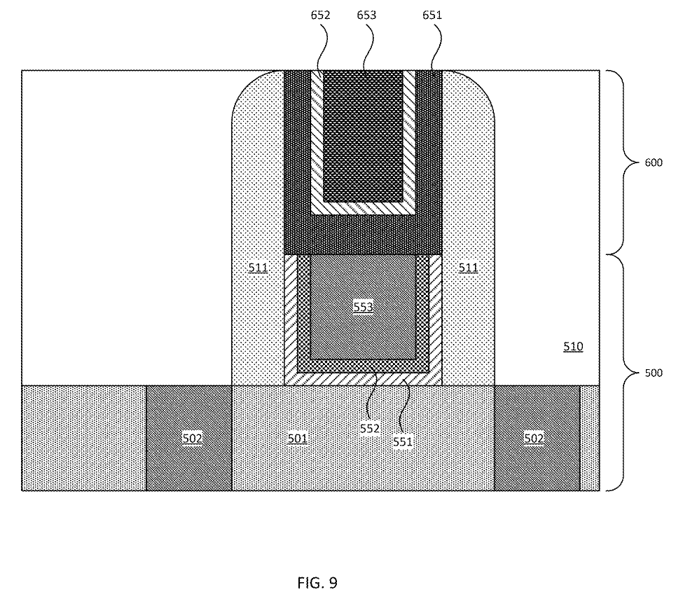

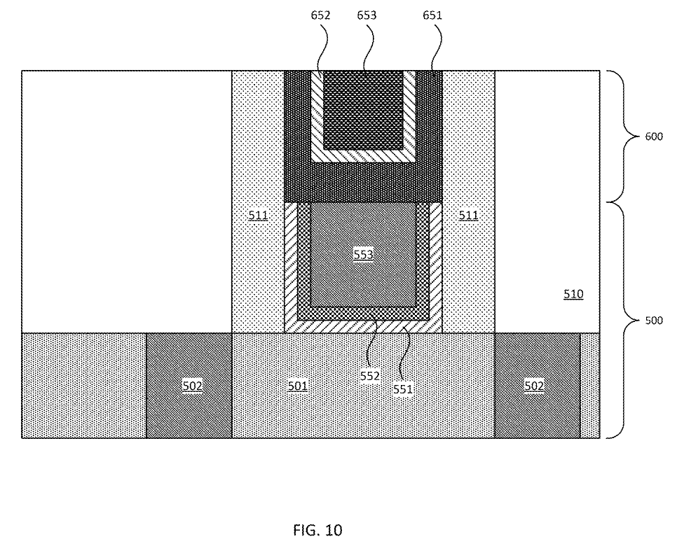

Embodiments of present invention further provide recessing the metal gate 550 in a selective etching process, such as a reactive-ion-etch (RIE) process, to create a recess 601 between the pair of sidewall spacers 511, as is illustrated in FIG. 8, such that the metal gate 550 may have a height lower than the sidewall spacers 511; filling the recess 601 with a conductive layer 651, an intermediate layer 652, and another conductive layer 653 on top of the intermediate layer 652, as is illustrated in FIG. 9. The conductive layer 651 may be a layer of titanium-nitride (TiN) and the conductive layer 653 may be a layer of tungsten (W), tantalum-nitride (TaN), copper (Cu), or other suitable conductive materials. In one embodiment, the intermediate layer 652 may be a dielectric layer of silicon-oxide (SiOx), silicon-nitride (SiN), or other suitable dielectric materials. In another embodiment, the intermediate layer 652 may be a ferroelectric layer. The conductive layer 651, the intermediate layer 652, and the conductive layer 653 together form a controlling capacitor 600. For example, the conductive layers 651 and 653 may be a first and a second conductive plate of the controlling capacitor 600 that are separated by the intermediate layer 652. Following the formation of the controlling capacitor 600, a chemical-mechanical-polishing (CMP) process may be applied to planarize a top surface of the controlling capacitor 600 and the dielectric layer 510, as is illustrated in FIG. 10, such that top surfaces of the sidewall spacers 511 are exposed for further processing.

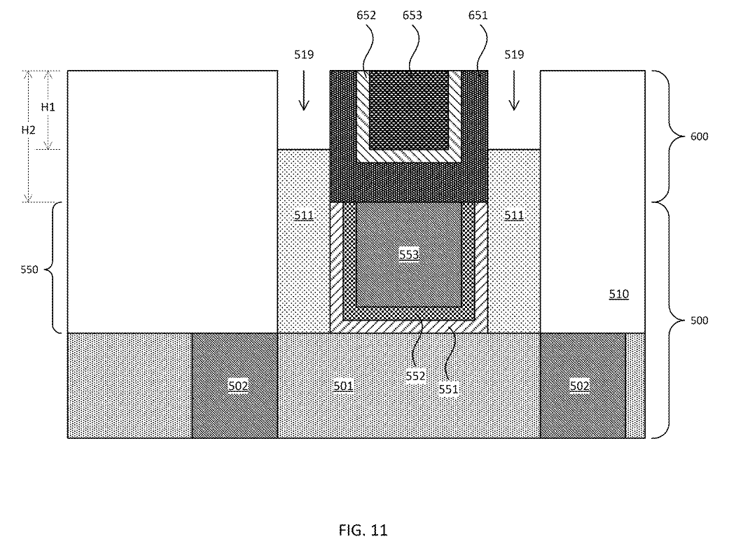

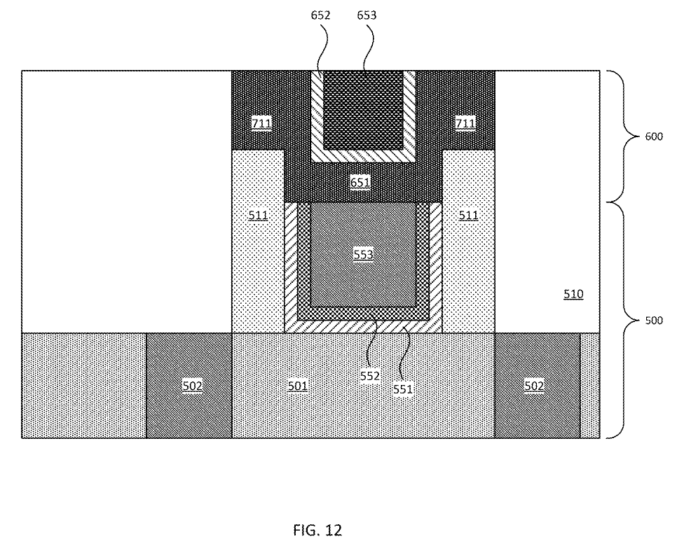

As is illustrated in FIG. 11, embodiments of present invention provide selectively etching the exposed sidewall spacers 511 to create recesses 519. The recesses 519 are surrounded by sidewalls of the dielectric layer 510 and sidewalls of the conductive layer 651 to have a depth H1 that is less than a height H2 of the controlling capacitor 600 such that the metal gate 550 underneath the controlling capacitor 600 may not be exposed by the recesses 519. In other words, a bottom surface of the recesses 519 is higher than a top surface of the metal gate 550 of the fin-type FET 500. Following creating the recesses 519, as is illustrated in FIG. 12, conductive material may be deposited in the recesses 519 thereby forming contact regions 711 above the rest of the sidewall spacers 511, and directly adjacent the conductive layer 651 of the controlling capacitor 600.

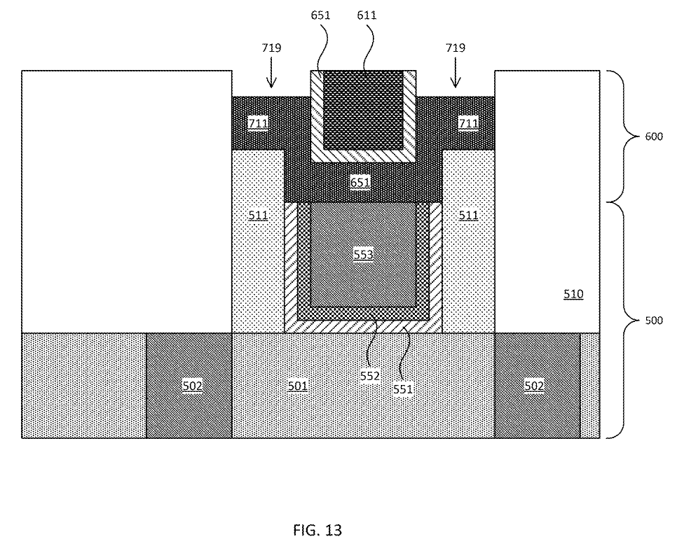

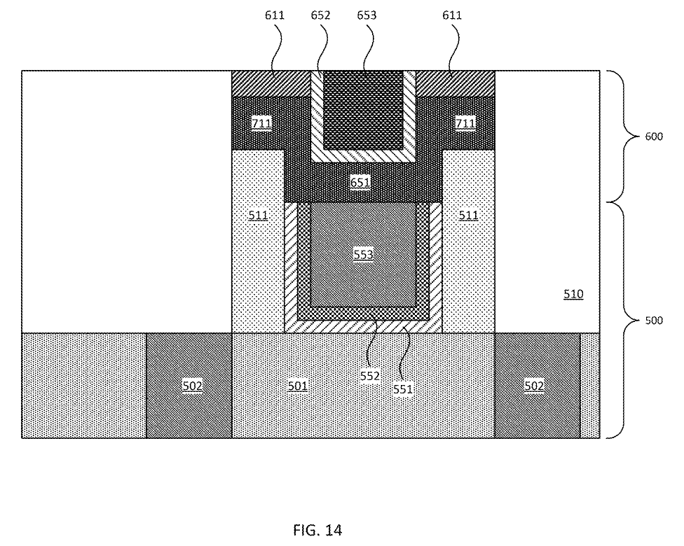

As is illustrated in FIG. 13, embodiments of present invention provide recessing the contact regions 711 and the conductive layer 651 to create recesses 719 and, as is illustrated in FIG. 14, depositing dielectric material in the recesses 719 to form isolating caps 611 on top of the conductive layer 651 and contact regions 711.

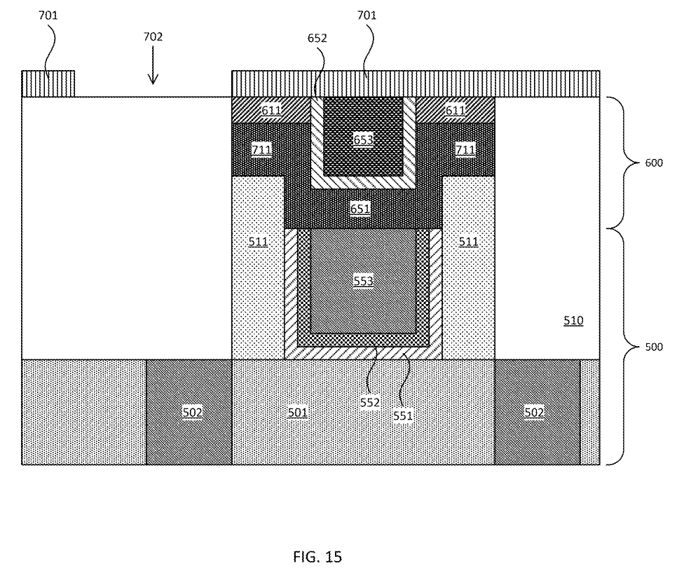

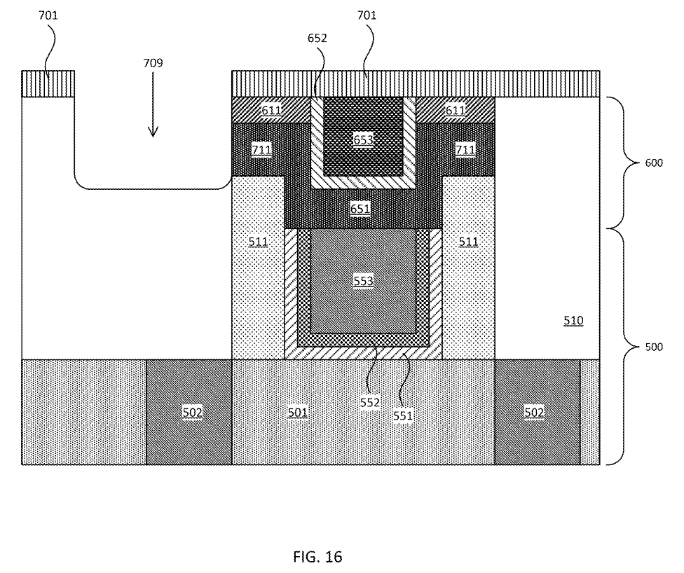

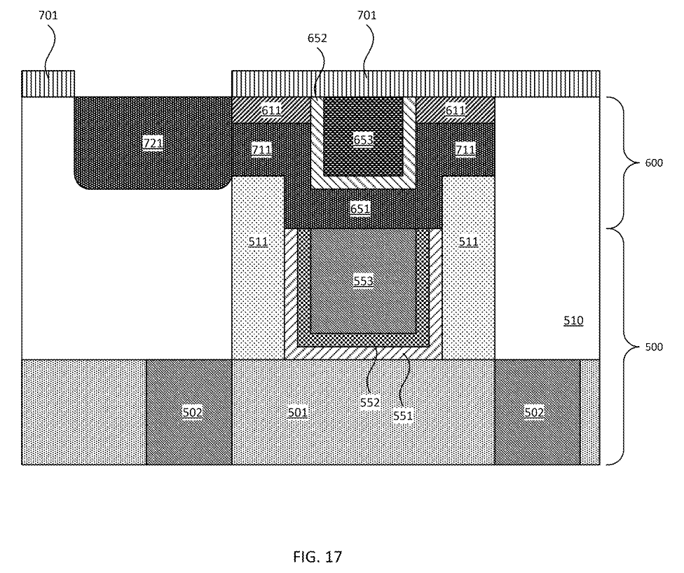

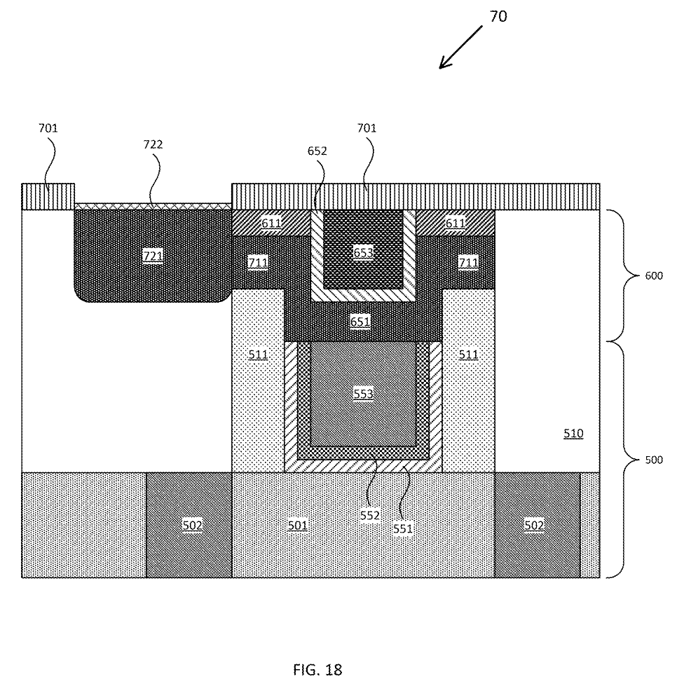

Embodiments of present invention then proceed to form a sensing surface of the sensing structure 70 that is conductively connected to the metal gate 550 of the fin-type FET 500. In doing so, embodiments of present invention provide forming a hard mask 701 on top of the dielectric layer 510 and above the controlling capacitor 600, as is illustrated in FIG. 15. The hard mask 701 includes an opening 702 that exposes a portion of the dielectric layer 510 that is horizontally directly adjacent to one of the isolating caps 611 and the contact region 711. Next, embodiments of present invention provide selectively etching the exposed dielectric layer 510, such as through a RIE process, to create an opening 709, as is illustrated in FIG. 16. The opening 709 exposes at least a portion of, and preferably entire sidewall of the contact region 711. Next, conductive material may be deposited into the opening 709, as is illustrated in FIG. 17, to form a sensing layer 721. The sensing layer 721 may be in direct contact, thereby conductively connected to the metal gate 550 of the fin-type FET 500 through the contact region 711 and the conductive layer 651. Following the formation of the sensing layer 721, a bio layer 722 may be formed on top of the sensing layer 721, as is illustrated in FIG. 18. The bio layer 722 may be a monolayer of biotin proteins and help bonding biomolecules to the sensing layer 721 during a sensing, detecting, and/or testing process of the biomolecules.

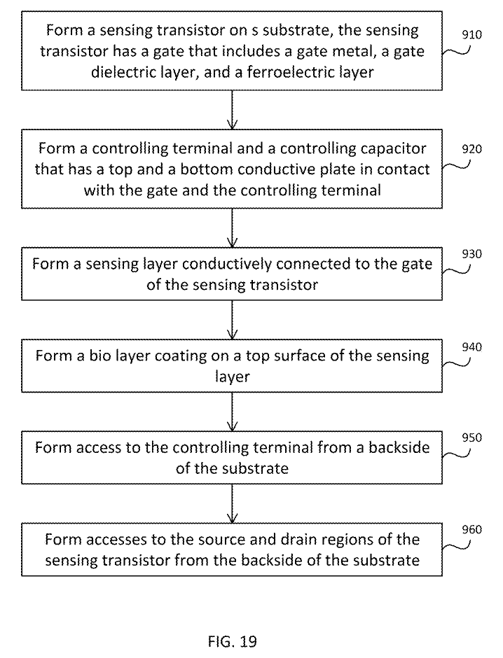

FIG. 19 is a demonstrative illustration of a flow-chart of a method of manufacturing a semiconductor structure according to embodiments of present invention. The method includes a step at (910) of forming a sensing transistor on s substrate, the sensing transistor has a gate that includes a gate metal, a gate dielectric layer, and a ferroelectric layer; a step at (920) of forming a controlling terminal and a controlling capacitor that has a top and a bottom conductive plate in contact with the gate and the controlling terminal; a step at (930) of forming a sensing layer conductively connected to the gate of the sensing transistor; a step at (940) of forming a bio layer coating on a top surface of the sensing layer; a step at (950) of forming access to the controlling terminal from a backside of the substrate; and a step at (960) of forming accesses to the source and drain regions of the sensing transistor from the backside of the substrate.

It is to be understood that the exemplary methods discussed herein may be readily incorporated with other semiconductor processing flows, semiconductor devices, and integrated circuits with various analog and digital circuitry or mixed-signal circuitry. In particular, integrated circuit dies can be fabricated with various devices such as field-effect transistors, bipolar transistors, metal-oxide-semiconductor transistors, diodes, capacitors, inductors, etc. An integrated circuit in accordance with the present invention can be employed in applications, hardware, and/or electronic systems. Suitable hardware and systems for implementing the invention may include, but are not limited to, personal computers, communication networks, electronic commerce systems, portable communications devices (e.g., cell phones), solid-state media storage devices, functional circuitry, etc. Systems and hardware incorporating such integrated circuits are considered part of the embodiments described herein. Given the teachings of the invention provided herein, one of ordinary skill in the art will be able to contemplate other implementations and applications of the techniques of the invention.

Accordingly, at least portions of one or more of the semiconductor structures described herein may be implemented in integrated circuits. The resulting integrated circuit chips may be distributed by the fabricator in raw wafer form (that is, as a single wafer that has multiple unpackaged chips), as a bare die, or in a packaged form. In the latter case the chip may be mounted in a single chip package (such as a plastic carrier, with leads that are affixed to a motherboard or other high-level carrier) or in a multichip package (such as a ceramic carrier that has surface interconnections and/or buried interconnections). In any case the chip may then be integrated with other chips, discrete circuit elements, and/or other signal processing devices as part of either an intermediate product, such as a motherboard, or an end product. The end product may be any product that includes integrated circuit chips, ranging from toys and other low-end applications to advanced computer products having a display, a keyboard or other input device, and a central processor.

The descriptions of various embodiments of present invention have been presented for the purposes of illustration and they are not intended to be exhaustive and present invention are not limited to the embodiments disclosed. The terminology used herein was chosen to best explain the principles of the embodiments, practical application or technical improvement over technologies found in the marketplace, and to enable others of ordinary skill in the art to understand the embodiments disclosed herein. Many modifications, substitutions, changes, and equivalents will now occur to those of ordinary skill in the art. Such changes, modification, and/or alternative embodiments may be made without departing from the spirit of present invention and are hereby all contemplated and considered within the scope of present invention. It is, therefore, to be understood that the appended claims are intended to cover all such modifications and changes as fall within the spirit of the invention.

What is claimed is:

1. A biosensor structure comprising:
a sensing transistor having a source region, a drain region, and a gate, wherein the gate includes a gate metal, a gate dielectric layer, and a ferroelectric layer and is directly above a channel region in a substrate between the source region and the drain region;
a sensing layer conductively connected to the gate metal of the gate; and
a bio layer on a top surface of the sensing layer.

2. The biosensor structure of claim 1, further comprising:
a controlling capacitor; and
a controlling terminal capacitively connected to the sensing transistor through the controlling capacitor,
wherein the controlling capacitor includes a top conductive plate, a bottom conductive plate, and a dielectric layer between the top conductive plate and the bottom conductive plate.

3. The biosensor structure of claim 2, wherein the sensing transistor and the controlling capacitor are at a frontside of the substrate and embedded in an interlevel dielectric (ILD) layer at a top surface of the substrate, and the controlling terminal is embedded in the ILD layer with access at a top surface of the ILD layer.

4. The biosensor structure of claim 2, wherein the sensing transistor and the controlling capacitor are at a frontside of the substrate and embedded in an interlevel dielectric (ILD) layer at a top surface of the substrate, and the controlling terminal is in the substrate with access at a backside of the substrate that opposes the frontside of the substrate.

5. The biosensor structure of claim 1, wherein the ferroelectric layer in the gate of the sensing transistor is a first ferroelectric layer, further comprising:
a controlling capacitor conductively connected to the sensing layer with the controlling capacitor having a top conductive plate, a bottom conductive plate, and a second ferroelectric layer between the top conductive plate and the bottom conductive plate, and
a controlling terminal conductively connected to the bottom conductive plate of the controlling capacitor.

6. The biosensor structure of claim 5, wherein the sensing transistor and the controlling capacitor are at a frontside of the substrate and embedded in an interlevel dielectric (ILD) layer at a top surface of the substrate, and the controlling terminal is embedded in the ILD layer and access to the controlling terminal is at a top surface of the ILD layer.

7. The biosensor structure of claim 5, wherein the sensing transistor and the controlling capacitor are at a frontside of the substrate and embedded in an interlevel dielectric (ILD) layer at a top surface of the substrate, and the controlling terminal is in the substrate and access to the controlling terminal is at a backside of the substrate opposite the frontside of the substrate.

8. A biosensor structure comprising:
a sensing transistor having a source region, a drain region, and a gate, wherein the gate is directly above a channel region in a substrate between the source region and the drain region and includes at least a gate metal and a gate dielectric layer;
a sensing layer conductively connected to the gate metal of the gate;
a bio layer on a top surface of the sensing layer; and
a controlling capacitor and a controlling terminal capacitively connected to the sensing transistor through the controlling capacitor,
wherein the controlling capacitor includes a top conductive plate, a bottom conductive plate, and a ferroelectric layer between the top conductive plate and the bottom conductive plate.

9. The biosensor structure of claim 8, wherein the ferroelectric layer in the controlling capacitor is a second ferroelectric layer, and wherein the gate of the sensing transistor further includes a first ferroelectric layer between the gate metal and the channel region in the substrate.

10. The biosensor structure of claim 9, wherein the sensing transistor and the controlling capacitor are at a frontside of the substrate and embedded in an interlevel dielectric (ILD) layer at a top surface of the substrate, and the controlling terminal is embedded in the ILD layer and access to the controlling terminal is at a top surface of the ILD layer.

11. The biosensor structure of claim 9, wherein the sensing transistor and the controlling capacitor are at a frontside of the substrate and embedded in an interlevel dielectric (ILD) layer at a top surface of the substrate, and the controlling terminal is in the substrate and access to the controlling terminal is at a backside of the substrate opposite the frontside of the substrate.

12. The biosensor structure of claim 9, wherein the first ferroelectric layer is a layer of X-doped HfO₂ where X is selected from a group consisting of Si, Zr, Pb, Fe, La, and Al.

13. The biosensor structure of claim 12, wherein the first ferroelectric layer is different from the second ferroelectric layer in material.

14. The biosensor structure of claim 9, wherein the first ferroelectric layer is between the gate metal and the gate dielectric layer.

15. A biosensor structure comprising:
a fin-type transistor having a source region, a drain region, and a gate, wherein the gate saddles over a fin structure in a substrate between the source region and the drain region; includes a gate metal, a gate dielectric layer, and a ferroelectric layer; and is surrounded by a pair of sidewall spacers;
a sensing layer conductively connected to the gate metal of the gate; and
a bio layer on a top surface of the sensing layer.

16. The biosensor structure of claim 15, further comprising a controlling capacitor directly on top of the gate of the fin-type transistor, wherein the controlling capacitor includes a top conductive plate, a bottom conductive plate, and a dielectric layer between the top conductive plate and the bottom conductive plate.

17. The biosensor structure of claim 16, wherein the gate of the fin-type transistor and the controlling capacitor are embedded in an interlevel dielectric (ILD) layer at a top surface of the substrate, further comprising a sensing layer embedded in the ILD layer, wherein the sensing layer is conductively connected to the bottom conductive plate of the controlling capacitor through a contact region above one of the pair of sidewall spacers.

18. The biosensor structure of claim 17, wherein the bottom conductive plate of the controlling capacitor is in direct contact with, thereby conductively connected to, the gate metal of the gate of the fin-type transistor.

19. The biosensor structure of claim 15, wherein the ferroelectric layer in the gate of the fin-type transistor is a first ferroelectric layer, further comprising a controlling capacitor directly on top of the gate of the fin-type transistor, wherein the controlling capacitor includes a top conductive plate, a bottom conductive plate, and a second ferroelectric layer between the top conductive plate and the bottom conductive plate.

20. The biosensor structure of claim 19, wherein the first and second ferroelectric layers are different in material, and are respectively a layer of X-doped HfO₂ where X is selected from a group consisting of Si, Zr, Pb, Fe, La, and Al.
